(19) United States
(12) Patent Application Publication
(10) Pub. No.: US 2025/0300835 A1
(43) Pub. Date: Sep. 25, 2025

(54) CONNECTION METHOD

(71) Applicant: SEIKO EPSON CORPORATION, Tokyo (JP)

(72) Inventors: Shun UEDA, MATSUMOTO-SHI (JP); Takumi MORIMOTO, MATSUMOTO-SHI (JP)

(21) Appl. No.: 19/082,626

(22) Filed: Mar. 18, 2025

(30) Foreign Application Priority Data
Mar. 25, 2024 (JP) 2024-047709

(51) Int. Cl. H04L 9/32

(52) U.S. Cl. CPC H04L 9/3236; H04L 9/3226

(57) ABSTRACT

An information terminal that has acquired identification information for identifying an output device generates a hash value based on the acquired identification information. The information terminal generates a first PIN code based on the generated hash value. The output device generates a hash value based on the identification information of the output device and generates and displays a second PIN code based on the hash value. The information terminal receives first input operation for inputting the second PIN code displayed by the output device to the information terminal and transmits a connection request signal to the output device when the second PIN code input to the information terminal and the first PIN code coincide.

The present application is based on, and claims priority from JP Application Serial Number 2024-047709, filed Mar. 25, 2024, the disclosure of which is hereby incorporated by reference herein in its entirety.

### BACKGROUND

### 1. Technical Field

The present disclosure relates to a connection method of connecting an information terminal to an output device.

### 2. Related Art

A projector disclosed in JP-A-2018-152663displays an identification code of the projector on a projection surface according to predetermined operation. In a technique disclosed in JP-A-2018-152663, when an identification code of the projector is input to an information terminal that is executing an application program for a display system, the information terminal transmits a connection request including the identification code to the projector. The projector disclosed in JP-A-2018-152663 permits connection of the information terminal to communication means when the identification code displayed on the projection surface or the like is included in the connection request received from the information terminal.

JP-A-2018-152663 is an example of the related art.

In the technique disclosed in JP-A-2018-152663, it is likely that the identification code of the projector leaks because of, for example, wiretapping of communication between the information terminal and the projector.

### SUMMARY

According to an aspect of the present disclosure, there is provided a connection method of connecting an output device and an information terminal, the connection method including: acquiring, with the information terminal, identification information for identifying the output device; generating a hash value with the information terminal based on the identification information acquired by the information terminal; generating a first identification code with the information terminal based on the hash value generated by the information terminal; acquiring the identification information with the output device; generating a hash value with the output device based on the identification information acquired by the output device; generating a second identification code with the output device based on the hash value generated by the output device; and receiving, with the information terminal, first input operation for inputting the second identification code generated by the output device to the information terminal and, when the second identification code input by the first input operation and the first identification code coincide, transmitting a connection request signal to the output device.

### BRIEF DESCRIPTION OF THE DRAWINGS

FIG. 1 is a diagram illustrating a configuration example of an information system according to an embodiment of the present disclosure.

FIG. 2 is a diagram illustrating an example of a standby screen displayed by an output device.

FIG. 3 is a diagram illustrating a configuration example of an information terminal.

FIG. 4 is a diagram illustrating an example of a UI screen displayed on a display device of the information terminal.

FIG. 5 is a flowchart illustrating a flow of processing in a connection method in the embodiment.

### DESCRIPTION OF EMBODIMENTS

Various technically preferable limitations are added to an embodiment explained below. However, embodiments of the present disclosure are not limited to the embodiment explained below.

### 1. Embodiment

FIG. 1 is a diagram illustrating a configuration example of an information system 1 according to an embodiment of the present disclosure. As illustrated in FIG. 1, the information system 1 includes an output device 10A, an output device 10B, and an information terminal 20. The output device 10 and the information terminal 20 are connected to a network NW such as a wired or wireless local area network (LAN).

Both of the output device 10A and the output device 10B are display devices that display images and are specifically projectors. When it is unnecessary to distinguish each of the output device 10A and the output device 10B, the output device 10A and the output device 10B are referred to as “output devices 10”. Another device such as a personal computer is connected to the output device 10 via the network NW. The output device 10 projects an image represented by image data supplied from the other device at a connection destination onto a projection surface such as a projection screen to thereby display the image. Examples of the other device in the present embodiment include the information terminal 20.

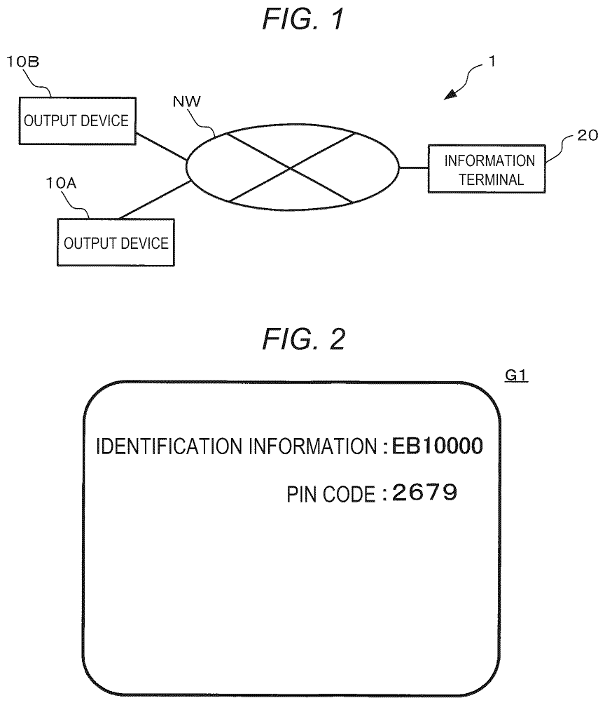

When a power supply (not illustrated in FIG. 1) of the output device 10 is turned on, the output device 10 displays a standby screen for waiting for connection of the other device on the projection surface. FIG. 2 is a diagram illustrating an example of a standby screen G1 displayed by the output device 10A. As illustrated in FIG. 2, the standby screen G1 includes a character string representing a name of the output device 10A and a character string representing a PIN code that is an identification code used when the other device is connected to the output device 10 via the network NW. As illustrated in FIG. 2, identification information of the output device 10A is “EB10000” and the PIN code is “2679”.

In the present embodiment, the identification information of the output device 10 is stored in advance in a storage device 250 of the information terminal 20 (a configuration of the information terminal 20 is explained in detail below). The output device 10 reads the identification information from the storage device 250 to thereby acquire the identification information of the output device 10. The output device 10 generates a PIN code in the following manner. First, the output device 10 generates a character string in which a specific peculiar character string is coupled to the identification information of the output device 10 (hereinafter, hashing target character string). In the present embodiment, “lcp1” is used as the peculiar character string. Therefore, in the present embodiment, the output device 10A generates “EB10000lcp1” as the hashing target character string. The peculiar character string is stored in the storage device 250 in advance like the identification information. As the specific peculiar character string, a different character string may be adopted every time the output device 10 is turned on or, for example, a character string representing a date (for example, 20240330 in the case of Mar. 30, 2024) or a cumulative number of times of connection between the output device 10 and the information terminal 20 (for example, 200 if the cumulative number of times of connection is 200) may be adopted. Subsequently, the output device 10 generates a hash value by inputting the hashing target character string to a predetermined hash function. Then, the output device 10 picks up a predetermined number (four in the present embodiment) of numbers from the head of the hash value and arrays the four numbers from the left to the right in the order of picking up the numbers to generate a PIN code. The identification information and the peculiar character string of the output device 10 may be stored in a storage device in the output device 10 in addition to the storage device 250. In this case, the output device 10 may read the identification information and the peculiar character string from the storage device of the output device 10.

For example, in the output device 10A, it is assumed that a hash value “abb267b9d8a8ee5b3 ⋅ ⋅ ⋅ 0” has been obtained by inputting “EB10000lcp1”, which is the hashing target character string, to a predetermined hash function. The output device 10A picks up four numbers “2”, “6”, “7”, and “9” in order from the head of the hash value and arrays the four numbers from the left to the right in the order of picking up the four numbers to generate the PIN code “2679”. The PIN code generated as explained above is displayed on the standby screen G1. The PIN code generated in the output device 10 is an example of a second identification code in the present disclosure.

The information terminal 20 is, for example, a personal computer. In the present embodiment, when a user of the information terminal 20 desires to connect the information terminal 20 to the output device 10A, the user needs to start an application program for the information system 1 in the information terminal 20 and input a PIN code displayed on the standby screen G1 displayed by the output device 10A to the information terminal 20. In this regard, the present embodiment is the same as the technique disclosed in JP-A-2018-152663. In the present embodiment, it is possible to connect the information terminal 20 to the output device 10 via the network NW without transmitting, via the network NW, a PIN code input to the information terminal 20 to the output device 10A, which is the feature of the present embodiment. The information terminal 20 that plays a central role in the present embodiment is mainly explained below.

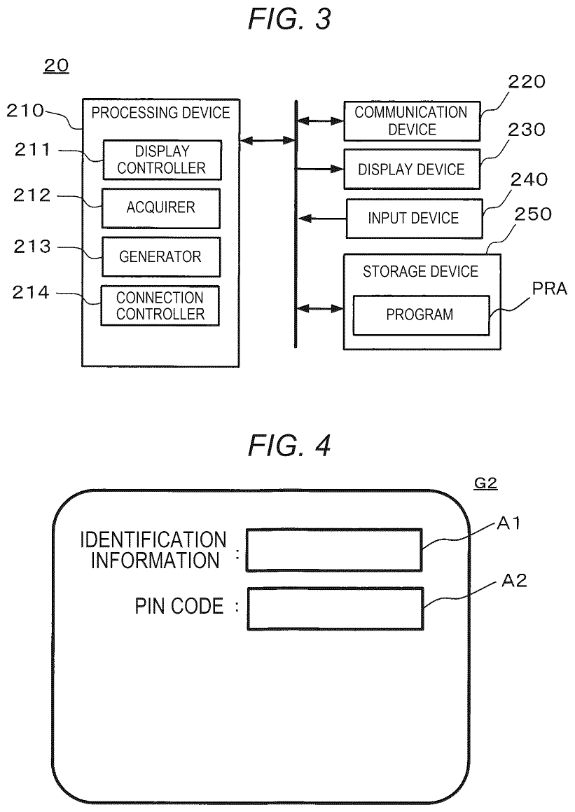

FIG. 3 is a diagram illustrating a configuration example of the information terminal 20. As illustrated in FIG. 3, the information terminal 20 includes a processing device 210, a communication device 220, a display device 230, an input device 240, and the storage device 250. The processing device 210 is one or more processors. Specifically, the processing device 210 is a central processing unit (CPU). The processing device 210 operates according to a program stored in the storage device 250 to thereby function as a control center of the information terminal 20. The communication device 220 is a device that performs wireless communication or wired communication with another device and includes, for example, an interface circuit. Specific examples of the other device that communicates with the communication device 220 include the output device 10. The display device 230 is a device that displays various images under control of the processing device 210 and is, for example, a liquid crystal display. The input device 240 includes, for example, an operation piece such as a numeric keypad and gives data representing content of operation of the user on the operation piece to the processing device 210.

The storage device 250 is a recording medium readable by the processing device 210. The storage device 250 includes, for example, a nonvolatile memory and a volatile memory. The nonvolatile memory is, for example, a read only memory (ROM), an erasable programmable read only memory (EPROM), or an electrically erasable programmable read only memory (EEPROM). The volatile memory is, for example, a random access memory (RAM). In the nonvolatile memory of the storage device 250, the peculiar character string (that is, “lcp1”) explained above and various programs are stored. Examples of the various programs stored in the nonvolatile memory include a kernel program and a program PRA. In FIG. 3, illustration of the kernel program is omitted. The kernel program is a program for causing the processing device 210 to implement an operating system (OS).

The processing device 210 reads the kernel program from the nonvolatile memory to the volatile memory at the opportunity of the start of power supply to the information terminal 20 and starts execution of the read kernel program. The processing device 210 operating according to the kernel program reads, according to operation on the input device 240, a program instructed to be started from the nonvolatile memory to the volatile memory and executes the read program. For example, when a start of the program PRA is instructed, the processing device 210 reads the program PRA from the nonvolatile memory to the volatile memory and starts executing the program PRA read to the volatile memory. The program PRA is the application program for the information system 1. The processing device 210 operating according to the program PRA functions as a display controller 211, an acquirer 212, a generator 213, and a connection controller 214 illustrated in FIG. 3. That is, each of the display controller 211, the acquirer 212, the generator 213, and the connection controller 214 illustrated in FIG. 3 is a software module implemented by causing the processing device 210 to operate according to the program PRA. A role of each of the display controller 211, the acquirer 212, the generator 213, and the connection controller 214 illustrated in FIG. 3 is as explained below.

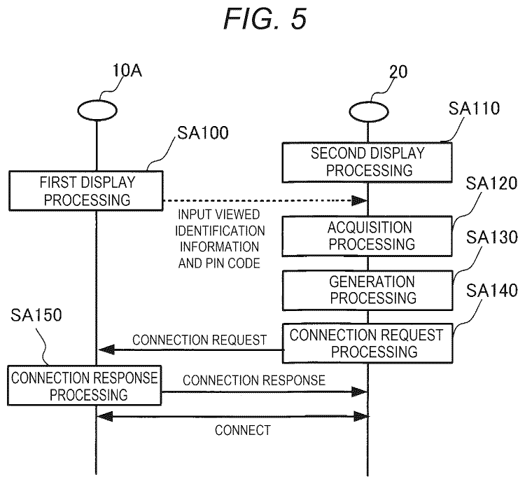

The display controller 211 displays, on the display device 230, a UI screen G2 for urging input of various information for connecting the information terminal 20 to the output device 10. FIG. 4 is a diagram illustrating an example of the UI screen G2. As illustrated in FIG. 4, an input box A1 and an input box A2 are provided in the UI screen G2. The input box A1 is an input region for inputting identification information of a device to which the information terminal 20 is connected. When the user of the information terminal 20 desires to connect the information terminal 20 to the output device 10A, the user inputs identification information displayed on the standby screen G1 displayed by the output device 10A to the input box A1 according to input operation on the input device 240. The input operation of inputting the identification information to the input box A1 is an example of second input operation in the present disclosure. The input box A2 is an input region for inputting a PIN code of the device to which the information terminal 20 is connected. When the user desires to connect the information terminal 20 to the output device 10A, the user inputs a PIN code displayed on the standby screen G1 displayed by the output device 10A to the input box A2 according to input operation on the input device 240. The input operation of inputting the PIN code to the input box A2 is an example of first input operation in the present disclosure.

The acquirer 212 acquires, from the input device 240, the identification information and the PIN code of the device to which the information terminal 20 is connected. In the present embodiment, the acquirer 212 acquires, from the input device 240, the identification information input by the input operation of the user, but may acquire the identification information from the output device 10 by communicating with the output device 10 using the communication device 220.

The generator 213 generates a PIN code based on the identification information acquired by the acquirer 212 and the peculiar character string explained above in the same procedure as in the case in the output device 10. Specifically, first, the generator 213 couples the peculiar character string to the identification information acquired by the acquirer 212 to generate a hashing target character string. Subsequently, the generator 213 inputs the generated hashing target character string to the same hash function as the hash function in the output device 10 to generate a hash value. Then, the generator 213 picks up a predetermined number (four in the present embodiment) of numbers from the head of the hash value and arrays the four numbers from the left to the right in the order of picking up the numbers to generate a PIN code. The PIN code generated by the generator 213 is an example of a first identification code in the present disclosure.

The connection controller 214 determines whether the PIN code generated by the generator 213 and the PIN code acquired by the acquirer 212 coincide. When the PIN code generated by the generator 213 and the PIN code acquired by the acquirer 212 do not coincide, the connection controller 214 displays an error message for urging reinput of identification information and a PIN code on the UI screen G2. In contrast, when determining that the PIN code generated by the generator 213 and the PIN code acquired by the acquirer 212 coincide, the connection controller 214 transmits, to the output device 10 indicated by the identification information acquired by the acquirer 212, a connection request not including the PIN code of the device. The output device 10 that has received the connection request via the network NW unconditionally returns a connection response and establishes a communication path between the output device 10 and a transmission source of the connection request. When the communication path is established between the output device 10 and the information terminal 20, the information terminal 20 and the output device 10 are connected. When receiving the connection request, the output device 10 unconditionally establishes the communication path between the output device 10 and the transmission source because authentication by the PIN code has already been executed in the transmission source. Since authentication using the PIN code is not performed in the output device 10, it is unnecessary to include the PIN code of the output device 10 in the connection request transmitted from the information terminal 20 to the output device 10. For this reason, in the present embodiment, the connection request transmitted by the connection controller 214 does not include the PIN code. Since the PIN code is not included in the connection request transmitted from the information terminal 20 to the output device 10, the PIN code does not leak even when the connection request is, for example, wiretapped.

The configuration of the information terminal 20 is as explained above.

Subsequently, with reference to FIG. 5, an operation executed by each of the information terminal 20 and the output device 10A in the connection method for connecting the information terminal 20 to the output device 10A is explained taking, as an example, a case in which the information terminal 20 is connected to the output device 10A. FIG. 5 is a diagram illustrating a flow of processing in the connection method. As illustrated in FIG. 5, the connection method includes first display processing SA100, second display processing SA110, acquisition processing SA120, generation processing SA130, connection request processing SA140, and connection response processing SA150. As illustrated in FIG. 5, the first display processing SA100 and the connection response processing SA150 are processing executed in the output device 10 and the second display processing SA110, the acquisition processing SA120, the generation processing SA130, and the connection request processing SA140 are processing executed in the information terminal 20. Processing contents of the first display processing SA100, the second display processing SA110, the acquisition processing SA120, the generation processing SA130, the connection request processing SA140, and the connection response processing SA150 are as explained below.

The first display processing SA100 is processing executed at the opportunity when the output device 10A is turned on. In the first display processing SA100, the output device 10A reads identification information from the storage device 250 to thereby acquire identification information of the output device 10A and generates a PIN code based on the acquired identification information and a predetermined peculiar character string. In the first display processing SA100, the output device 10 displays the standby screen G1 including the acquired identification information and the generated PIN code on the projection surface. In this operation example, the identification information included in the standby screen G1 is “EB10000” and the PIN code is “2679”. The user of the information terminal 20 views the standby screen G1 to thereby grasp the identification information and the PIN code.

The second display processing SA110 is processing executed at the opportunity when input operation for instructing a start of the program PRA is performed on the input device 240. In the second display processing SA110, the processing device 210 functions as the display controller 211 and displays the UI screen G2 on the display device 230. The user of the information terminal 20 inputs the identification information of the output device 10A and the PIN code, which are grasped by viewing the standby screen G1, to each of the input boxes A1 and A2 according to input operation on the input device 240. As explained above, the identification information grasped from the standby screen G1 by the user of the information terminal 20 is “EB10000” and the PIN code grasped from the standby screen G1 by the user is “2679”. Therefore, “EB10000” is input to the input box A1 and “2679” is input to the input box A2.

In the acquisition processing SA120 executed in the information terminal 20 following the second display processing SA110, the processing device 210 functions as the acquirer 212. In the acquisition processing SA120, the processing device 210 acquires, from the input device 240, the identification information and the PIN code of the device to which the information terminal 20 is connected. In this operation example, since “EB10000” is input to the input box A1 and “2679” is input to the input box A2, the processing device 210 acquires “EB10000” as the identification information and acquires “2679” as the PIN code.

In the generation processing SA130 executed following the acquisition processing SA120 in the as the generator 213. In the generating processing SA130, the processing device 210 couples the peculiar character string explained above to the identification information acquired in the acquiring processing SA120 to generate a hashing target character string. As explained above, since the identification information acquired in the acquisition processing SA120 in this operation example is “EB10000” and the peculiar character string is “lcp1”, “EB10000lcp1” is generated as the hashing target character string. Subsequently, the processing device 210 inputs the hashing target character string to the same hash function as the hash function in the output device 10 to generate a hash value. Then, the processing device 210 picks up a predetermined number (four in the present embodiment) of numbers from the head of the hash value and arrays the four numbers from the left to the right in the order of picking up the numbers to generate a PIN code. In this operation example, a hash value “abb267b9d8a8ee5b3 ⋅ ⋅ ⋅ 0” is obtained by inputting “EB10000lcp1”, which is the hashing target character string, to a predetermined hash function and a PIN code “2679” is generated by picking up four numbers “2”, “6”, “7”, and “9” in order from the head of the hash value and arraying the four numbers from the left to the right in the order of picking up the four numbers.

In the connection request processing SA140 executed following the generation processing SA130 in the as the connection controller 214. In the connection request processing SA140, the processing device 210 determines whether the PIN code generated in the generation processing SA130 and the PIN code acquired in the acquisition processing SA120 coincide and, when the PIN codes do not coincide, displays an error message on the UI screen 2 and, on the other hand, when the PIN codes coincide, transmits, to a device indicated by the identification information acquired in the acquisition processing SA120, a connection request not including a PIN code of the device. In this operation example, the PIN code acquired in the acquisition processing SA120 is “2679” and the PIN code generated in the generation processing SA130 is also “2679”. Therefore, both the PIN codes coincide. For this reason, in the connection request processing SA140 in this operation example, the connection request is transmitted to a device, identification information of which is “EB10000”.

The connection response processing SA150 is processing executed in the output device 10 at the opportunity when a connection request is received via the network NW. In the connection response processing SA150, the output device 10 unconditionally establishes a communication path between the output device 10 and a transmission source of the connection request and the transmission source and the output device 10 are connected. Thereafter, the output device 10 displays, on the projection surface, an image represented by image data transmitted from the information terminal 20 via the network NW.

According to the present embodiment, a PIN code generated by the output device 10 is not transmitted and received via the network NW. It is unlikely that the PIN code leaks because of wiretapping on the network NW. According to the present embodiment, unless all of the identification information of the output device 10, the specific peculiar character string, and the hash function leak, the PIN code of the output device 10 cannot be correctly generated. Therefore, fabrication of the PIN code can be avoided.

### 2. Modifications

The embodiment explained above can be modified as explained below.

(1) The output device 10 in the embodiment explained above is the projector. However, the output device 10 may be a printer or may be a scanner. The information terminal 20 in the embodiment explained above is the personal computer. However, the information terminal 20 may be a smartphone or may be a tablet terminal. In the embodiment explained above, the PIN code is generated in each of the output device 10 and the information terminal 20 based on the identification information of the output device 10 and the peculiar character string. However, each of the output device 10 and the information terminal 20 may generate the PIN code based only on the identification information of the output device 10, in other words, using the identification information itself of the output device 10 as the hashing target character string. Even in a mode in which the PIN code is generated based on only the identification information of the output device 10, the PIN code of the output device 10 cannot be correctly generated unless all of the identification information of the output device 10 and the hash function leak. Therefore, fabrication of the PIN code can be avoided.

(2) The display controller 211, the acquirer 212, the generator 213, and the connection controller 214 in the embodiment explained above are software modules. However, any one, any two, any three, or all of the display controller 211, the acquirer 212, the generator 213, and the connection controller 214 may be hardware modules such as an application specific integrated circuit (ASIC). Even when at least one of the display controller 211, the acquirer 212, the generator 213, and the connection controller 214 is a hardware module, the same effects as the effects of the embodiment explained above is achieved.

(3) The program PRA may be manufactured alone and may be provided for a fee or free of charge. Specific aspects at the time of providing the program PRA include an aspect in which the program PRA is written in a computer-readable recording medium such as a flash ROM and provided and an aspect in which the program PRA is provided by being downloaded through an electric communication line such as the Internet. By causing a general computer to operate according to the program PRA provided in these aspects, it is possible to cause the computer to function as the information terminal 20 in the embodiment explained above.

### 3. Summary of the Present Disclosure

The present disclosure is not limited to the embodiment and the modifications explained above and can be implemented in various aspects in a range not departing from the spirit of the present disclosure. For example, the present disclosure can also be implemented by aspects explained below. The technical features in the embodiment explained above corresponding to technical features in the aspects described below can be replaced or combined as appropriate in order to solve a part or all of the problems of the present disclosure or in order to achieve a part or all of the effects of the present disclosure. The technical features can be deleted as appropriate unless the technical features are described as essential technical features in the present specification.

A summary of the present disclosure is appended below.

### Appendix 1

A connection method according to the present disclosure is a connection method of connecting an output device and an information terminal, the connection method including: acquiring, with the information terminal, identification information for identifying the output device; generating a hash value with the information terminal based on the identification information acquired by the information terminal; generating a first identification code with the information terminal based on the hash value generated by the information terminal; acquiring the identification information with the output device; generating a hash value with the output device based on the identification information acquired by the output device; generating a second identification code with the output device based on the hash value generated by the output device; and receiving, with the information terminal, first input operation for inputting the second identification code generated by the output device to the information terminal and, when the second identification code input by the first input operation and the first identification code coincide, transmitting a connection request signal to the output device. With the connection method of the present aspect, the second identification code generated by the output device is not transmitted to the information terminal via a communication network. It is unlikely that the second identification code leaks because of wiretapping on the communication network.

### Appendix 2

A connection method according to a more preferable aspect is the connection method described in the appendix 1, wherein the generating the hash value with the information terminal based on the identification information acquired by the information terminal includes: acquiring a peculiar character string with the information terminal; and generating the hash value based on the identification information acquired by the information terminal and the peculiar character string acquired by the information terminal, and the generating the hash value with the output device based on the identification information acquired by the output device includes: acquiring the peculiar character string with the output device; and generating the hash value based on the identification information acquired by the output device and the peculiar character string acquired by the output device. According to this aspect, security is improved compared with the aspect in which the hash value is generated based on only the identification information.

### Appendix 3

A connection method according to another preferable aspect is the connection method described in the appendix 1 or the appendix 2, wherein the output device is a display device that displays an image to thereby output the image, the connection method further includes: displaying the identification information with the output device; and receiving, with the information terminal, second input operation for inputting the identification information displayed by the output device to the information terminal, and acquiring, with the information terminal, the identification information for identifying the output device is acquiring the identification information input by the second input operation. According to this aspect, the user can connect the information terminal to the display device by inputting two pieces of information displayed on the display device.

What is claimed is:

1. A connection method of connecting an output device and an information terminal, the connection method comprising:
acquiring, with the information terminal, identification information for identifying the output device;
generating a hash value with the information terminal based on the identification information acquired by the information terminal;
generating a first identification code with the information terminal based on the hash value generated by the information terminal;
acquiring the identification information with the output device;
generating a hash value with the output device based on the identification information acquired by the output device;
generating a second identification code with the output device based on the hash value generated by the output device; and
receiving, with the information terminal, first input operation for inputting the second identification code generated by the output device to the information terminal and, when the second identification code input by the first input operation and the first identification code coincide, transmitting a connection request signal to the output device.

2. The connection method according to claim 1, wherein
the generating the hash value with the information terminal based on the identification information acquired by the information terminal includes:
acquiring a peculiar character string with the information terminal; and
generating the hash value based on the identification information acquired by the information terminal and the peculiar character string acquired by the information terminal, and
the generating the hash value with the output device based on the identification information acquired by the output device includes:
acquiring the peculiar character string with the output device; and
generating the hash value based on the identification information acquired by the output device and the peculiar character string acquired by the output device.

3. The connection method according to claim 1, wherein
the output device is a display device that displays an image to thereby output the image,
the connection method further comprises:
displaying the identification information with the output device; and
receiving, with the information terminal, second input operation for inputting the identification information displayed by the output device to the information terminal, and
the acquiring, with the information terminal, the identification information for identifying the output device is acquiring the identification information input by the second input operation.
